(19) United States
(12) Patent Application Publication
(10) Pub. No.: US 2026/0036956 A1
(43) Pub. Date: Feb. 5, 2026

(54) COMPRESSED SEQUENCE-TO-SEQUENCE MODELLING

(71) Applicant: DeepMind Technologies Limited, London (GB)

(72) Inventors: Massimo Nicosia, Zurich (CH); Francesco Piccinno, Zurich (CH)

(21) Appl. No.: 18/793,163

(22) Filed: Aug. 2, 2024

(51) Int. Cl. G05B 17/02

(52) U.S. Cl. CPC G05B 17/02

(57) ABSTRACT

A method performed by one or more computers and for generating an output token sequence from an input token sequence. The method comprises processing an input token sequence using a sequence-to-sequence machine learning model to generate an output token sequence. The sequence-to-sequence machine learning model has a vocabulary comprising primary tokens for representing token sequences and pointer tokens for representing pointers to token sequences. At least one of the input token sequence and the output token sequence is a compressed token sequence comprising a respective one or more pointer subsequences. Each pointer subsequence comprises one or more pointer tokens representing a pointer to a corresponding earlier subsequence of primary tokens in the compressed token sequence.

### BACKGROUND

This specification relates to processing inputs using neural networks to generate output sequences.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes a system implemented as computer programs on one or more computers in one or more locations that uses a sequence-to-sequence machine learning model to generate an output token sequence from an input token sequence.

As one example, some implementations may be used for automatic code generation. For example, the sequence-to-sequence machine learning model can be configured to process an input token sequence that represents words, wordpieces or characters in a natural language to generate an output token sequence that represents instructions in a computer programming or markup language, or instructions for controlling an application program to perform a task, e.g., build a data item such as an image or web page. Alternatively or additionally, the input token sequence can represent instructions in a computer programming or markup language and the output token sequence can be a refactored, corrected, updated, extended or otherwise modified version of the instructions.

In one aspect there is provided, a method performed by one or more computers and for generating an output token sequence from an input token sequence. The method comprises processing an input token sequence using a sequence-to-sequence machine learning model to generate an output token sequence. The sequence-to-sequence machine learning model has a vocabulary comprising primary tokens for representing token sequences (e.g., uncompressed token sequences) and pointer tokens for representing pointers to token sequences. At least one of the input token sequence and the output token sequence (i.e., the input token sequence and/or the output token sequence) is a compressed token sequence comprising a respective one or more pointer subsequences. Each pointer subsequence comprises one or more pointer tokens representing a pointer to a corresponding earlier (i.e., preceding in the token sequence) subsequence of primary tokens in the compressed token sequence.

For example, the sequence-to-sequence machine learning model can be a language model, e.g., a Large Language Model (LLM) or a Visual Language Model (VLM). The language model can, for example, be implemented as a neural network having an appropriate architecture, e.g., a Transformer neural network. The input token sequence can be derived from a prompt received from a user, e.g., a user query comprising text. The output token sequence can be a response to the prompt, e.g., a response to a user query.

In implementations, the method can comprise generating the input token sequence from an initial token sequence (e.g., an uncompressed input token sequence) comprising primary tokens. Generating the input token sequence can comprise identifying one or more matching subsequences of primary tokens in the initial token sequence. Each matching subsequence is a match to a corresponding earlier subsequence in the initial token sequence. The method can then comprise, for each of the one or more matching subsequences, replacing one or more occurrences of the matching subsequence in the initial token sequence with a corresponding pointer subsequence comprising one or more pointer tokens representing a pointer to the corresponding earlier subsequence in the initial token sequence. Thus, the (uncompressed) initial token sequence can be compressed before being provided as an input to the sequence-to-sequence machine learning model.

As one example, the matching subsequence can be determined to match the corresponding earlier subsequence using a matching criterion, e.g., for text subsequences, a case-insensitive matching criterion can be used, such that two subsequences match if they correspond to the same text string irrespective of whether the characters in the text string are upper case or lower case. As another example, the matching criterion can be based on an edit distance between the two text subsequences (strings), i.e., based on a count of the minimum number of operations required to transform one of the strings into the other string. For example, two strings may be determined to match if the edit distance is less than or equal to a pre-determined number, e.g., 0, 1, 2, 5, 10 and so on, Such a matching criterion may allow typographical errors to be corrected, for example.

Alternatively, the matching subsequence can be determined to match the corresponding earlier subsequence using a strict matching criterion, i.e., if and only if the two subsequences are identical. In that case, the method comprises: identifying one or more repeated (i.e., identically matching) subsequences of primary tokens in the uncompressed input token sequence, each repeated subsequence occurring more than once in the uncompressed input token sequence; and for each of the one or more repeated subsequences, replacing one or more occurrences of the repeated subsequence in the (uncompressed) initial token sequence with a corresponding pointer subsequence comprising one or more pointer tokens representing a pointer to an earlier occurrence of the repeated subsequence in the initial token sequence.

In some implementations, the output token sequence is a compressed output token sequence. The method can then further comprise generating an uncompressed output token sequence, which can comprise replacing each pointer subsequence with the primary tokens of the corresponding earlier subsequence in the compressed output token sequence. Thus, the compressed output token sequence generated by the sequence-to-sequence machine learning model can decompressed, e.g., prior to the (uncompressed) output token sequence being provided as a response to a user query.

The compressed token sequence can be compressed using a dictionary or substitution coding algorithm, such as one of a family of Lempel-Ziv or “LZ” compression algorithms, e.g., an LZ77 algorithm or an LZ Predictor (LZP) algorithm. In other words, the compression/decompression can be performed losslessly, such that there is no loss of information when introducing or resolving the pointer subsequences, e.g., when obtaining the input token sequence by compressing an initial token sequence.

As one example, each pointer subsequence can comprise one or more pointer tokens representing a length of the corresponding subsequence of primary tokens. The length of the corresponding earlier subsequence of primary tokens can then be used to determine a location for the corresponding earlier subsequence (i.e., a location of the primary tokens that make up the corresponding earlier subsequence) in the compressed token sequence, e.g., using a rolling hashing scheme, such as is used in an LZP algorithm. In some implementations, e.g., where a LZ77 algorithm is used, each pointer subsequence can also comprise one or more pointer tokens representing a corresponding offset in the compressed token sequence for the corresponding earlier subsequence relative to the pointer subsequence. Once the location (e.g., offset) and length of the subsequence of primary tokens in the compressed token sequence has been determined, the pointer tokens of the pointer subsequence can be replaced by the subsequence of primary tokens. Repeating this process for each of the pointer subsequences allows an uncompressed token sequence to be obtained from the compressed token sequence.

In some other implementations, e.g., when a non-strict matching criterion is used, the compression may be lossy to some extent, such that the compression may not be perfectly reversible.

In some implementations, the sequence-to-sequence machine learning model is an autoregressive sequence-to-sequence machine learning model. In other words, the output token sequence can be created by generating each particular token in the output token sequence (except the first token of the output token sequence) conditioned on a current input token sequence that includes at least some of the tokens that precede the particular token in the output token sequence, i.e., the tokens that have already been generated for any previous positions in the compressed output token sequence that precede the particular position of the particular token.

In some implementations, the input token sequence can represent a text query, e.g., from a user, and the output token sequence can be provided as a response to the text query. For example, the input token sequence can comprise primary tokens that represent respective multi-character substrings of a text query.

For example, the compressed token sequence can comprise pointer subsequences of pointer tokens representing pointers to corresponding earlier subsequences of primary tokens representing elements of a mark-up language or a data exchange language, such as JavaScript Object Notation (JSON), Extensible Mark-up Language (XML), or Hypertext Mark-up Language (HTML) and so on, or a computer programming language, such as Python, C, C++, Java, JavaScript etc. or a language used to manage data, e.g., in a relational database management system, such as Structured Query Language (SQL). In such cases, e.g., in the case of JSON/XML, the compressed token sequence can have 20-30% fewer tokens than the corresponding uncompressed token sequence.

In some implementations, the sequence-to-sequence machine learning model can comprise a base neural network configured to generate an embedding of an input token sequence. The base neural network is trained to generate embeddings of input token sequences as a part of another sequence-to-sequence model that has a vocabulary that does not comprise the pointer tokens, i.e., it comprises primary tokens for representing token sequences, but does not comprise pointer tokens for representing pointers to token sequences. The base neural network can be combined with adapter neural networks layers to obtain the sequence-to-sequence machine learning model, e.g., using an architecture described in Chen et al., “LoRA: Low-Rank Adaptation of Large Language Models”, arXiv:2106.09685, or Zettlemoyer et al., “QLoRA: Efficient Finetuning of Quantized LLMs”, arXiv:230.14314. By combining the adapter neural network layers with pre-trained base neural network layers, the performance of the sequence-to-sequence machine learning model can be improved significantly whilst minimising training costs. In particular, the adapter neural network layers can have significantly fewer trainable parameters than the base neural network.

For example, the base neural network can comprise blocks of base neural network layers and the sequence-to-sequence machine learning model can comprise one or more adapter blocks. Each adapter block comprises adapter neural network layers defined by low-rank factorization matrices. For example, the product of the low-rank factorization matrices may approximate a higher-dimensional matrix, e.g., weight matrix. The adapter neural network layers can be arranged to modify the output of a corresponding one or more of the blocks of base neutral network layers. For example, each adapter block can process an input to the corresponding one or more of the blocks of base neural network layers to generate a corresponding output that is combined with the output of the one or more of the blocks of base neural network layers to generate an updated or modified embedding of the token sequence.

In some implementations, the neural network layers of the blocks are stored on a user computing device (i.e., local to the user), such as a mobile device, e.g., a mobile phone, tablet or a smart speaker, and the adapter subnetworks are stored on one or more server devices (i.e., remote from the user). Thus, parameters of the adapter subnetworks may not be accessible to users and can therefore remain private.

In other implementations, the adapter subnetworks are stored on the user computing device and the base neural network layers of the blocks are stored on one or more server devices. Thus, parameters of the adapter subnetworks may not be accessible only to one or more selected users. Thus, the adapter subnetworks may be used to “personalize” the sequence-to-sequence model neural network for a particular one or more users.

In some implementations, the adapter neural network layers can have been trained using compressed input token sequences and/or compressed output token sequences while trainable parameters of the base neural network layers are frozen. Alternatively (or additionally), the adapter neural network layers and the base neural network layers can be trained jointly.

In another aspect, there is provided a method performed by one or more computers and for generating an output token sequence from an input token sequence. The method comprises generating a compressed input token sequence comprising primary tokens for representing token sequences. Generating the compressed input token sequence comprises: identifying one or more matching subsequences of primary tokens in the input token sequence, each matching subsequence being a match to a corresponding earlier subsequence in the input token sequence; and for each of the one or more matching subsequences, replacing one or more occurrences of the matching subsequence in the input token sequence with a corresponding pointer subsequence comprising one or more pointer tokens representing a pointer to the corresponding earlier subsequence in the input token sequence. The method further comprises processing the compressed input token sequence using a sequence-to-sequence machine learning model to generate an output token sequence, the sequence-to-sequence machine learning model having a vocabulary comprising the primary tokens (e.g., a set of primary tokens) and the pointer tokens.

For example, the output token sequence can comprise a respective one or more pointer subsequences, each pointer subsequence comprising one or more pointer tokens representing a pointer to the corresponding subsequence of primary tokens in the output token sequence. The method can further comprise replacing each pointer subsequence in the output token sequence with the primary tokens of the corresponding earlier subsequence in the output token sequence.

In another aspect, there is provided a method performed by one or more computers and for generating an output token sequence from an input token sequence. The method comprises processing an input token sequence using a sequence-to-sequence machine learning model to generate a compressed output token sequence, the sequence-to-sequence machine learning model having a vocabulary comprising primary tokens for representing token sequences and pointer tokens for representing pointers to token sequences. The compressed output token sequence comprises a respective one or more pointer subsequences, each pointer subsequence comprising one or more pointer tokens representing a pointer to a corresponding earlier subsequence of primary tokens in the compressed output token sequence.

In some implementations, the method can further comprise replacing each pointer subsequence with the primary tokens of the earlier occurrence of the corresponding subsequence in the compressed output token sequence. The method can also further comprise replacing each pointer subsequence with the primary tokens of the earlier occurrence of the corresponding subsequence in the output token sequence.

In some implementations, the method can comprise transmitting the compressed token

sequence to or from a user computer device, e.g., between a user computer device and a server that hosts the sequence-to-sequence machine learning model. For example, the user computer device can generate a compressed input sequence and then transmit the compressed input token sequence to the server for processing by the machine learning model. Additionally or alternatively, the server may generate a compressed output token sequence using the sequence-to-sequence machine learning model, and transmit the compressed output token sequence to the user computer device for processing (e.g., decompressing).

In some implementations, the method is for controlling a mechanical system (e.g., a robot or mechanical agent) acting in a real world environment to perform a specified task. For example, the input token sequence can represent one or more observations of the real world environment obtained from one or more sensors, and the output token sequence can represent instructions (e.g., control signals) for controlling the mechanical system in the real world environment. For example, the instructions may specify one or more actions for the mechanical system to perform in order to carry out the specified task. The method may further comprise using the output token sequence to control the mechanical system in the real world environment.

In some examples, the mechanical agent has an agent control system to control actions of the mechanical agent. The input token sequence can represent a control signal received from the agent control system. For example, the mechanical agent can comprise an autonomous or semi-autonomous vehicle navigating in the real-world environment, and the output token sequence can represent one or more actions to control movement of the vehicle in the real-world environment.

As one example, the input token sequence can be derived from at least one observation characterizing a current state of the real-world environment that is generated from measurements from one or more sensors configured to sense the real-world environment. The input token sequence may additionally represent data characterizing planned navigation of an agent, and the output token sequence can characterize an action to be performed by the agent in response to the observation. The method can comprise controlling navigation of the agent based on the output token sequence.

In some implementations, the input token sequence and output token sequence each relate to an environment, such as a real world environment.

For example, the method can be for controlling a manufacturing process and the input token sequence can represent an environment, such as a manufacturing plant for manufacturing a product. The manufacturing plant can comprise a plurality of manufacturing units configured such that an intermediate version or component of the product is moveable between the manufacturing units during manufacture of the product. The method can then be used for controlling one or more of the manufacturing units, or for controlling movement of the intermediate version or component of the product between the manufacturing units. The input token sequence can be generated using one or more observations of the manufacturing units or of the movement obtained from one or more sensors. For example, the one or more observations can be processed to generate a natural language representation of the one or more observations, which is represented by the input token sequence. The input token sequence can additionally relate to an action that controls operation of one or more of the manufacturing units or that controls the movement. The method can further comprise using the output token sequence generated in response to the input token sequence to control operation of one or more of the manufacturing units or to control the movement.

In some examples, the manufacturing plant has a plant control system to control the manufacturing units or to control the movement. The input token sequence can be based on one or more control signals received from the plant control system, e.g., based on one or more natural language queries generated using the control signal(s).

In some implementations, the environment is a real-world environment and the method is used for diagnosing a fault in a mechanical system operating in the real world environment. For example, the input token sequence can be generated by obtaining, from one or more sensors, one or more observations of the mechanical system, and processing the one or more observations to generate the input token sequence, e.g., from a natural language representation of the one or more observations. The method can further comprise using the output token sequence to identify a fault in the mechanical system. For example, the output token sequence can comprise a natural language description identifying the fault. The method can additionally comprise taking one or more corrective or protective actions in response to the identified fault, e.g., sounding an alarm, or shutting off the mechanic system, and so on.

As a further example, the environment can be a computer security system and the method can be used for determining whether a computer security incident has been resolved on a computer network. The input token sequence can comprise data characterizing the computer security incident derived from system logs, data characterizing the computer network, or both. The output token sequence can represent a status of the computer network based on the data characterizing the computer security incident. The method can additionally comprise taking one or more corrective or protective actions based on the output token sequence indicating that the computer security incident has not been resolved.

In another example, the environment can be a computer software evaluation system and the method can be used for determining whether a piece of software code will execute or has executed as intended on a computer system. The input token sequence can comprise data characterizing one or more of: the piece of software code, execution of the piece of software code, the computer system on which the code will execute or has executed, artifacts of execution of the software code, or one or more validation rules for the execution of the piece of software code. The output token sequence can, for example, indicate one or more (potential) flaws in the software code and/or suggestions for improving the software code, e.g., to remove the flaw(s).

In a yet further example, the environment can be a real-world environment and the method can be used for controlling one or more electrical components in a facility comprising a plurality of electrical components. The input token sequence can be generated by obtaining, from one or more sensors, one or more observations of the facility, and processing the one or more observations to generate the input token sequence. The output token sequence can, for example, represent instructions (e.g., control signals) for controlling the one or more electrical components in the facility. The method can therefore comprise controlling the one or more electrical components in the facility based on the output token sequence. The one or more electrical components can, for example, control heating and/or cooling of the facility.

Using techniques described in this specification the computational cost of sequence-to-sequence modelling can be reduced. For example, the number of computer operations and/or computer memory needed to operate the sequence-to-sequence machine learning model can be reduced through the use of the compressed token sequences described herein.

Compressing the input token sequence can also allow more efficient use of the sequence-to-sequence machine learning model. For example, where the sequence-to-sequence machine learning model is a Transformer neural network having a fixed context length, compressing the input token sequence can allow more information to be provided within the fixed context length. For example, where the sequence-to-sequence machine learning model is an LLM, a longer prompt can be used compared to other LLMs that have not been trained to process compressed input sequences.

As the sequence-to-sequence machine learning model can generate compressed output token sequences the model needs to emit fewer output tokens to provide the same information as sequence-to-sequence machine learning models that generate output token sequences, resulting in faster inference time, particularly for autoregressive machine learning models. Such improvements in inference time can allow the sequence-to-sequence machine learning model to be used in real-time applications, for example.

In some implementations, the input token sequence can be generated and compressed on a client device, e.g., a mobile computing device, before transmission to another one or more computer devices for processing using the sequence-to-sequence machine learning model. Similarly, the other one or more computer devices may transmit a compressed output token sequence to the client device for decompression. Thus, by compressing the input and/or output token sequence, bandwidth to and from the client device can be saved.

The details of one or more embodiments of the subject matter of this specification are set forth in the accompanying drawings and the description below.

Other features, aspects, and advantages of the subject matter will become apparent from the description, the drawings, and the claims.

### BRIEF DESCRIPTION OF THE DRAWINGS

FIG. 1 shows an example sequence generation system.

FIG. 2 shows a token sequence and compressed token sequence.

FIG. 3 shows a sequence-to-sequence model.

FIG. 4 is a flow diagram of an example process.

Like reference numbers and designations in the various drawings indicate like elements.

### DETAILED DESCRIPTION

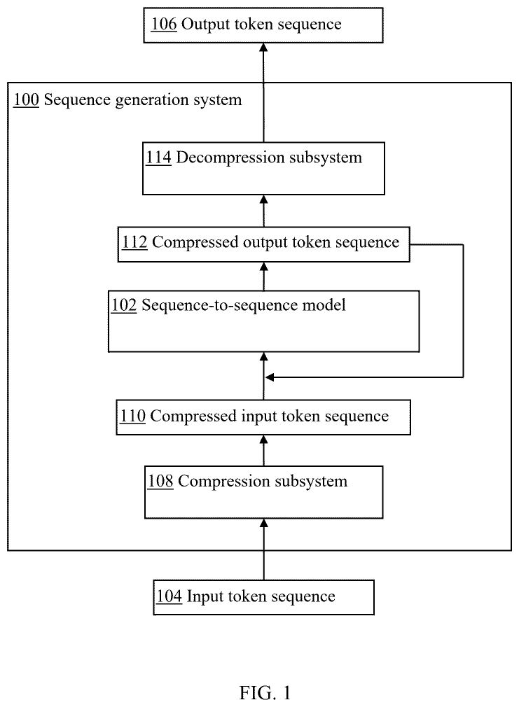

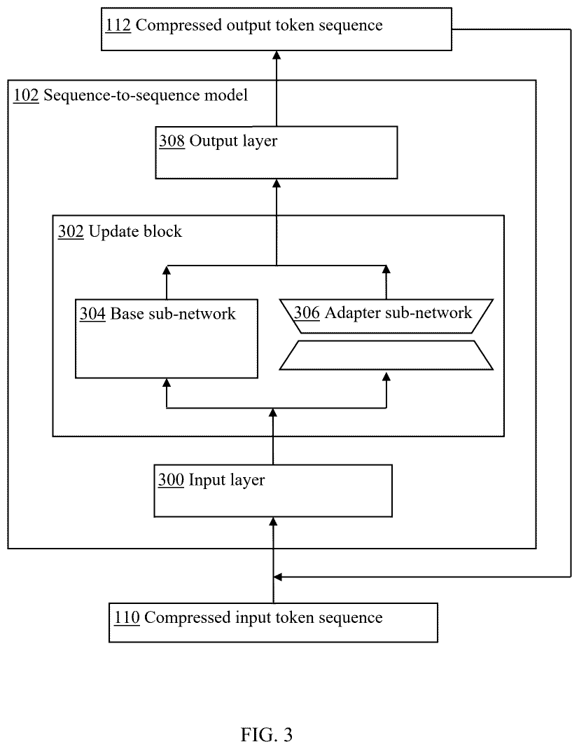

FIG. 1 shows an example sequence generation system 100, which is an example of a system implemented as computer programs on one or more computers in one or more locations in which the systems, components, and techniques described below are implemented. The sequence generation system 100 uses a sequence-to-sequence model 102 to process an input token sequence 104 to generate an output token sequence 106. The input token sequence 104 and the output token sequence 106 each comprise a respective plurality of primary tokens for selected from a vocabulary of primary tokens for representing (e.g., uncompressed) token sequences. The primary tokens may, for example, represent words, wordpieces or characters, and the sequence-to-sequence model 102 may be a language model, e.g., a large language model (LLM). Details of the sequence-to-sequence model 102 are discussed below in connection with FIG. 3.

The sequence generation system 100 comprises a compression subsystem 108 that processes the input token sequence 104 to generate a compressed input token sequence 110. The compression subsystem 108 applies a lossless compression algorithm to the input token sequence 104 to generate the compressed input token sequence 110. The compression algorithm can be a dictionary or substitution coding algorithm, such as one of a family of Lempel-Ziv or “LZ” compression algorithms, e.g., an LZ77 algorithm or an LZP algorithm. Thus, the compressed input token sequence 110 generated by the compression subsystem 108 has fewer tokens than the corresponding (uncompressed) input token sequence 104.

The compression subsystem 108 generates the compressed input token sequence 110 from the input token sequence 104 by replacing each of one or more matching subsequences of primary tokens (e.g., repeated subsequences, i.e., non-overlapping subsequences that occur more than once in the input token sequence) by a corresponding pointer subsequence representing a pointer to a corresponding earlier subsequence in the input token sequence 104. That is, the compression subsystem 108 identifies one or more matching subsequences that match a corresponding earlier subsequence in the input token sequence 104 and then generates the compressed input token sequence 110 by replacing one or more of each of the matching subsequences in the input token sequence with a corresponding pointer subsequence representing a pointer to the corresponding earlier subsequence in the input token sequence. Each pointer subsequence comprises one or more pointer tokens selected from a vocabulary of pointer tokens for representing pointers to token sequences. The compressed input token sequence 110 therefore includes, for each of the repeated subsequences of the input token sequence 104 identified by the compression subsystem 108, (i) at least a first subsequence comprising primary tokens; and (ii) at least one pointer subsequence comprising one or more pointer tokens representing a pointer to the first subsequence.

The compressed input token sequence 110 comprises tokens selected from a vocabulary that comprises primary tokens for representing token sequences and pointer tokens for representing pointers to token sequences. For example, the vocabulary may comprise a set of primary tokens and a set of pointer tokens. The set of primary tokens and the set of pointer tokens may, for example, be disjoint, i.e., the two sets may have no tokens in common.

The pointer subsequence can be any appropriate representation of a pointer to an earlier subsequence of primary tokens. For example, the pointer subsequence can represent a length of the earlier subsequence, from which an offset for the corresponding earlier subsequence can be implicitly derived using a rolling hashing scheme. For example, the pointer subsequence can comprise a single number representing the length of the earlier subsequence.

Alternatively or additionally, the pointer subsequence can comprise one or more pointer tokens representing an offset from the position of the pointer subsequence in the compressed input token sequence 110 to a position of the earlier subsequence in the compressed input token sequence 110. In other words, each pointer sequence can comprise a respective <offset, length> pair.

In general, the number of (pointer) tokens in the pointer subsequence is less than the number of tokens in the earlier subsequence to which the pointer subsequence refers, so that the compressed input token sequence 110 is shorter than the input token sequence 104. In implementations where the pointer subsequences comprise a length of the earlier subsequence, the number of pointer tokens may, for example, be around 16-32 pointer tokens. In implementations where the pointer subsequences additionally comprise an offset, the number of pointer tokens may be around 128-256 pointer tokens, for example.

The sequence-to-sequence model 102 processes the compressed input token sequence 110 to generate a compressed output token sequence 112 in which one or more occurrences of a matching subsequence in the compressed output token sequence 112 are replaced with a corresponding pointer subsequence comprising one or more pointer tokens representing a pointer to the corresponding earlier subsequence in the compressed output token sequence 112. For example, the sequence-to-sequence model 102 can be a causal Transformer neural network e.g., an encoder-decoder Transformer neural network with a causal Transformer decoder or a causal decoder-only Transformer neural network, which auto-regressively generates the tokens in the compressed output token sequence 112. For example, the sequence-to-sequence model 102 can have the architecture of a large language model (LLM) neural network.

The sequence-to-sequence model 102 can be an autoregressive sequence-to-sequence model, in which case the compressed output token sequence 112 is generated autoregressively. In other words, the compressed output token sequence 112 is created by generating each particular token in the output sequence conditioned on a current input sequence that includes at least some of the tokens that precede the particular token in the output sequence, i.e., the tokens that have already been generated for any previous positions in the compressed output token sequence 112 that precede the particular position of the particular token.

The sequence generation system 100 further comprises a decompression subsystem 114 that decompresses the compressed output token sequence 112 by replacing each of the pointer subsequences with the tokens of the corresponding subsequence of the compressed output token sequence 112.

In some implementations, the compression subsystem 108 can be omitted from the sequence generation system 100, such that the sequence-to-sequence model 102 processes the input token sequence 104, rather than the compressed input token sequence 110, to generate the compressed output token sequence 112. Alternatively, the sequence-to-sequence model 102 may generate an output token sequence 106 that does not comprise pointer subsequences, in which case, the decompression subsystem can be omitted from the sequence generation system 100.

In some implementations, the sequence generation system 100 performs a machine translation task, e.g., by processing the compressed input token sequence 110 that represents a sequence of text, e.g., a sequence of words, phrases, characters, or word pieces, in one language, to generate an output that can be a translation of the sequence of text into another language, i.e., a sequence of text in the other language that is a translation of the input sequence of text. As a particular example, the task can be a multi-lingual machine translation task, where the machine learning model is configured to translate between multiple different source language-target language pairs. In this example, the source language text can be augmented with an identifier that indicates the target language into which the sequence-to-sequence model 102 should translate the source language text.

In some implementations, the sequence-to-sequence model 102 is configured to perform a natural language processing or understanding task, e.g., an entailment task, a paraphrase task, a textual similarity task, a sentiment task, a sentence completion task, a grammaticality task, and so on, that operates on the (compressed) input token sequence 104 representing text in some natural language.

In some implementations, the machine learning model is configured to perform a text generation task, where the input token sequence 104 represents a sequence of text, and the output token sequence 106 is another sequence of text, e.g., a completion of the input sequence of text, a response to a question posed in the input sequence, or a sequence of text that is about a topic specified by the first sequence of text.

Some implementations may be used for automatic code generation. For example, the input token sequence 104 can comprise primary tokens that represent words, wordpieces or characters in a first natural language and the downstream task can be to generate an output token sequence 106 that represent instructions in a computer programming or mark-up language, or instructions for controlling an application program to perform a task, e.g., build a data item such as an image or web page.

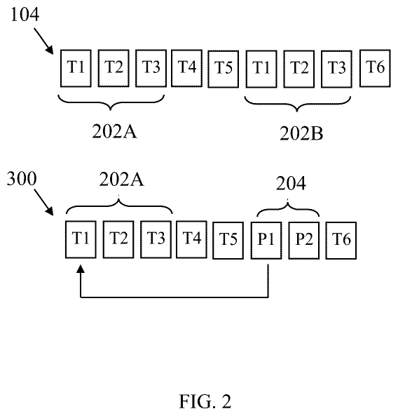

FIG. 2 shows an example of an input token sequence 104 that comprises a plurality of primary tokens T1 . . . T6 selected from a vocabulary {T1-T6 . . . }. In this example, the input token sequence 104 comprises a first occurrence of a subsequence 202A “T1, T2, T3” and a second occurrence of the subsequence 202B. Following compression by the compression subsystem 108, the compressed input token sequence 110 includes the first occurrence of the subsequence 202A and a pointer subsequence 204 that replaces the second occurrence of the subsequence 202B and comprises pointer tokens P1, P2 that represent a pointer to the first occurrence of the subsequence 202A. The tokens of the compressed input sequence 110 are selected from a vocabulary {T1-T6 . . . P1, P2 . . . } that comprises the primary tokens and the pointer tokens.

FIG. 3 shows the sequence-to-sequence model 102, which in this example is a causal decoder-only Transformer neural network that uses one or more input neural network layers 300, one or more update blocks 302 for processing the compressed input token sequence 110, and a one or more output neural layers 308 to obtain the compressed output token sequence 112. The update block 302 comprises a base sub-network 304 configured to process a representation of the compressed token sequence 110 generated by the one or more input neural network layers 300 to generate an output for determining a next token in the compressed output token sequence 112.

For example, the sequence-to-sequence model 102 can have the architecture of a large language model (LLM) neural network. As one example, the sequence-to-sequence model 102 may comprise a multimodal machine learning model trained to perform multimodal tasks that involve processing a combination of an image and text to generate an output that performs an image processing task. Some example multimodal machine learning models with which the techniques described herein may be used include: Flamingo (Alayrac et al. arXiv:2204.14198); ALIGN (Jia et al., arXiv:2102.05918); PaLI (Chen et al. arXiv:2209.06794); and PaLI-X (Chen et al. arXiv:2305.18565).

As used herein an image may be any still or moving image, i.e., the image may be part of a video, in 2D or 3D, and may be a monochrome, color or hyperspectral image, i.e., comprising monochrome or color pixels. As defined herein an “image” includes a point cloud, e.g., from a LIDAR system, and a “pixel” includes a point of the point cloud. The image may have been captured by a camera or other image sensor from the real world, and objects in the image or video may comprise physical objects, represented by the image or video.

As one example, the input token sequence can be generated by processing pixels of the image, e.g., using an image encoder neural network, to generate a set of patch embeddings for the image. Each patch embedding can represent values of the pixels defining the image content of a corresponding patch (region) of the image. Each patch embedding can be discretized (quantized) to obtain a corresponding image token for processing by the sequence-to-sequence model 102. That is, the primary tokens can comprise image tokens in addition to, or instead of text tokens. Subsequences of image tokens can be compressed in the same way as, or a similar way to, text tokens, e.g., based on one or more matching criteria, which can comprise a strict matching criterion, requiring exact matches between image tokens, or a less strict matching criterion that requires only an approximate match between image tokens.

The base sub-network 304 comprises a succession of self-attention neural network layers (not shown). A self-attention neural network layer has an attention layer input for each element of the input and is configured to apply an attention mechanism over the attention layer input to generate an attention layer output for each element of the input. There are many possible attention mechanisms that may be used. The transformer neural network may be referred to as a decoder-only Transformer neural network in the sense that it can be based on just the decoder of the original transformer architecture (Vaswani et al., 2017 arXiv:1706.03762).

The update block 302 also comprises an adapter sub-network 306 configured to process a compressed token sequence in parallel with the processing performed by the base sub-network 304, i.e., the adapter sub-network 306 receives the same input as the base sub-network. The respective outputs of the base sub-network are combined before being provided to either another update block 302 or another base sub-network 304, to update the representation of the token sequence, or in the case of the final update block 302, to the one or more output layers 308 for generating the next token in the compressed output token sequence 112. The output layer(s) 308 can, for example, generate a distribution over the tokens of the vocabulary of the sequence-to-sequence model 102. The next token of the compressed output token sequence 112 can then be obtained by sampling from the distribution, e.g., by selecting the most likely next token.

After a first token of the compressed output token sequence 112 has been generated, it may be appended to the compressed input token sequence 110 to generate an updated input token sequence for processing by the sequence-to-sequence model 102. That is, the sequence-to-sequence model 102 can be an auto-regressive neural network that generates (compressed) output token sequences 112, e.g., an auto-regressive self-attention neural network that includes causally-masked self-attention layers.

In more detail, the neural network 102 can be referred to as an auto-regressive neural network, i.e., because the neural network auto-regressively generates an output sequence of tokens. More specifically, the auto-regressively generated output is created by generating each particular token in the output sequence conditioned on a current input sequence that includes at least some of the tokens that precede the particular token in the output sequence, i.e., the tokens that have already been generated for any previous positions in the output sequence that precede the particular position of the particular token.

For example, the neural network 102 can be an auto-regressive attention neural network that includes (i) a plurality of attention blocks that each apply a self-attention operation and (ii) an output subnetwork that processes an output of the last attention block to generate a score distribution over tokens in the vocabulary, e.g., a score distribution used for selecting an output token, e.g., by sampling from the score distribution or selecting a most likely token according to the score distribution. The self-attention operation applied by some or all of the attention blocks can be causally-masked, so that, for each position in the sequence, only the tokens at the position and at positions preceding the position are assigned non-zero attention weights.

The adapter sub-network 306 comprises one or more neural network layers having trainable parameters defining respective weight matrices of the adapter sub-network 306. The number of trainable parameters is generally significantly smaller than the number of parameters defining the base sub-network 304. The weight matrices of the adapter sub-network 306 can be low-rank factorization matrices. For example, the low-rank factorization matrices can comprise a first matrix of size d×r that is multiplied by a second matrix of size r×d, in which d is the length of a representation of the sequence of tokens provided as input to the adapter-sub network 306 and r is significantly less than d. By contrast, the weight matrices of the base sub-network 304 may have dimensions of d×d. The architecture of the adapter sub-network 306 may, for example, be as described in Hu et al. LoRA: Low-Rank Adaptation of Large Language Models, arXiv:2106.09685.

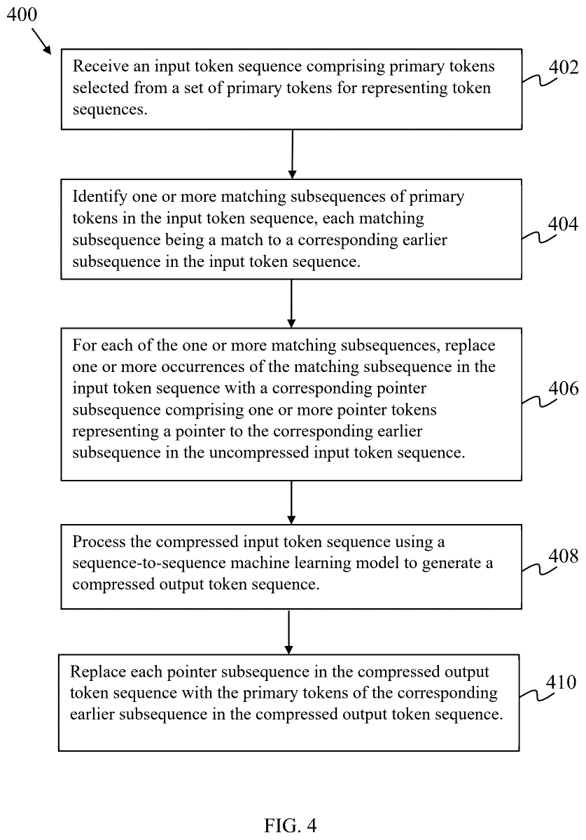

FIG. 4 is a flow diagram of an example process 400 for generating an output token sequence from an input token sequence using a sequence-to-sequence machine learning model. For convenience, the process 400 will be described as being performed by a system of one or more computers located in one or more locations. For example, a sequence generation system, e.g., the sequence generation system 100 of FIG. 1, appropriately programmed in accordance with this specification, can perform the process 400.

The system receives an input token sequence comprising primary tokens selected from a set of primary tokens for representing token sequences (step 402).

The system identifies one or more repeated subsequences of primary tokens in the input token sequence, each matching subsequence occurring more than once in the input token sequence (step 404).

The system compresses the input token sequence to obtain a compressed input token sequence by, for each of the matching subsequences, replacing one or more occurrences of the matching subsequence in the input token sequence with a corresponding pointer subsequence comprising one or more pointer tokens representing a pointer to the corresponding earlier subsequence in the input token sequence (step 406).

The system processes the compressed input token sequence using a sequence-to-sequence machine learning model to generate a compressed output token sequence. The sequence-to-sequence machine learning model has a vocabulary that comprises the primary tokens and the pointer tokens (step 408).

The tokens in the vocabulary can have any appropriate format such that each token is unique from each other token and can be processed as input by the machine learning model. For example, the tokens can each be one-hot encoded vectors that each have a “one” in along a different dimension. As another example, the tokens can each be different integers.

The system then replaces each pointer subsequence in the output token sequence with the primary tokens of the earlier corresponding subsequence in the output token sequence (step 410).

In some other implementations of the process 400, the sequence-to-sequence machine learning model can generate an uncompressed output token sequence, i.e., an output token sequence that does not comprise pointer subsequences, in which case, the decompression step (step 410) can be omitted. Similarly, in some cases, the input token sequence may be input to the sequence-to-sequence machine learning model without first being compressed, in which case, the compression steps (steps 404 and 406) can be omitted from the process 400.

### Applications of the Described Systems and Techniques

The described systems and techniques may be applied to a wide range of different types of input token sequence and output token sequence. In implementations of the described techniques the tokens may represent, characterize, or encode any type of information in a sequence e.g., stream of data. The term “represent” is used generally to refer to any way in which a token can encode part of a sequence. The tokens may include marker tokens, such as a start of sequence token, an end of sequence token, and a separator token (indicating a separation or break between two distinct parts of a sequence).

In some implementations the input tokens (i.e., the tokens of the input token sequence) and the output tokens (i.e., the tokens of the output token sequence) each represent words, wordpieces or characters in a natural language. A wordpiece may be a sub-word (part of a word), and may be an individual letter or character. As used here, “characters” includes Chinese and other similar characters, as well as logograms, syllabograms and the like.

Some of these implementations may be used for natural language tasks such as providing a natural language response to a natural language input, e.g., for question answering, or for text completion. In some implementations the input token sequence may represent text in a natural language and the output token sequence may represent text in the same natural language, e.g., a longer item of text. For example, in some implementations the input sequence may represent text in a natural language and the output token sequence may represent the same text with a missing portion of the text added or filled in. For example, the output token sequence may represent a predicted completion of text represented by the input sequence. Such an application may be used, e.g., to provide an auto-completion function e.g., for natural language-based search. In some implementations the input token sequence may represent a text in a natural language e.g., posing a question or defining a topic, and the output token sequence may represent a text in a natural language which is a response to the question or about the specified topic.

As another example, the input token sequence may represent a first item of text and the output token sequence may represent a second, shorter item of text, e.g., the second item of text may be a summary of a passage that is the first item of text. As another example the input token sequence may represent a first item of text and the output token sequence may represent an aspect of the first item of text, e.g., it may represent an entailment task, a paraphrase task, a textual similarity task, a sentiment analysis task, a sentence completion task, a grammaticality task, and in general any natural language understanding task that operates on a sequence of text in some natural language e.g., to generate an output that classifies or predicts some property of the text. For example, some implementations may be used to identify a natural language of the first item of text, or of spoken words where the input is audio (as described below).

Some implementations may be used to perform (neural) machine translation. Thus in some implementations the input tokens represent words, wordpieces, or characters in a first natural language and the output tokens represent words, wordpieces or characters in a second, different natural language. That is, the input token sequence may represent input text in the first language and the output token sequence may represent a translation of the input text into the second language.

Some implementations may be used for automatic code generation. For example, the input token sequence may represent words, wordpieces or characters in a first natural language and the output token sequence may represent instructions in a computer programming or mark-up language, or instructions for controlling an application program to perform a task e.g., build a data item such as an image or web page. Alternatively, the input token sequence may represent instructions in a computer programming or mark-up language, or instructions for controlling an application program to perform a task, and the output token sequence may represent modified instructions (e.g., in the same language), such as instructions that have been corrected, updated, extended or otherwise improved by the sequence-to-sequence machine learning model.

Some implementations may be used for speech recognition. In such applications the input token sequence may represent spoken words and the output token sequence may represent a conversion of the spoken words to a machine-written representation e.g., text. Then the input token sequence may comprise primary tokens representing an audio data input including the spoken words e.g., characterizing a waveform of the audio in the time domain or in the time-frequency domain. The output token sequence may represent words, wordpieces, characters, or graphemes of a machine-written, e.g., text, representation of the spoken input, that is representing a transcription of the spoken input.

Some implementations may be used for handwriting recognition. In such applications the input token sequence may represent handwritten words, syllabograms or characters and the output token sequence may represent a conversion of the input sequence to a machine-written representation e.g., text. Then the input token sequence may comprise primary tokens representing portions of the handwriting and the output token sequence may represent words, wordpieces, characters or graphemes of a machine-written, e.g., text, representation of the spoken input.

Some implementations may be used for text-to-speech conversion. In such applications the input token sequence may represent text and the output token sequence may represent a conversion of the text to spoken words. Then the input token sequence may comprise primary tokens representing words or wordpieces or graphemes of the text and the output token sequence may represent portions of audio data for generating speech corresponding to the text, e.g., tokens characterizing a portion of a waveform of the speech in the time domain or in the time-frequency domain, or phonemes.

In some implementations, the input token sequence and the output token sequence represent different modalities of input. For example, the input token sequence may represent text in a natural language and the output token sequence may represent an image or video corresponding to the text; or vice-versa. In general, the primary tokens may represent image or video features and a sequence of such tokens may represent an image or video. There are many ways to represent an image (or video) using tokens. As one example, an image (or video) may be represented as a sequence of regions of interest (RoIs) in the image, optionally including one or more primary tokens for global image features. For example, an image may be encoded using a neural network to extract RoI features; optionally (but not essentially) a token may also include data, e.g., a position encoding, representing a position of the RoI in the image. As another example, the primary tokens may encode color or intensity values for pixels of an image. As another example, some image processing neural network systems, e.g., autoregressive systems, naturally represent images as sequences of image features. As another example, a transformer-based sequence-to-sequence neural network system (e.g., as previously described) may be used to process images instead of or as well as text (e.g., if trained on images instead of or as well as text).

Thus in some implementations at least one of the input token sequence and the output token sequence is a sequence representing an image or video, and the primary tokens represent the image or video. For example, the input token sequence may be a sequence of text, the input tokens may represent words, wordpieces, or characters and the output sequence may comprise output tokens representing an image or video, e.g., described by the text, or providing a visual answer to a question posed by the text, or providing a visualization of a topic of the text. In another example, the input token sequence may comprise a sequence of primary tokens representing an image or video, and the output tokens may represent words or wordpieces, or characters representing text, e.g., for a description or characterization of the image or video, or providing an answer to a question posed visually by the image or video, or providing information on a topic of a topic of the image or video.

In some other implementations, both the input token sequence and the output token sequence may represent an image or video, and both the input tokens and the output tokens may represent a respective image or video. In such implementations, the method/system may be configured to perform an image or video transformation. For example, the input token sequence and the output token sequence may represent the same image or video in different styles e.g., one as an image the other as a sketch of the image; or different styles for the same item of clothing.

In some implementations, the input token sequence represents a sequence of actions to be performed by an agent, e.g., a mechanical agent in a real-world environment implementing the actions to perform a mechanical task. The output token sequence may comprise a modified sequence of actions e.g., one in which an operating parameter, such as a speed of motion or power consumption, has a limited value; or one in which or safety or other boundary is less likely to be crossed. Then both the input tokens and the output tokens may represent the actions to be performed.

In some implementations, the input token sequence represents a sequence of health data and the output token sequence may comprise a sequence of predicted treatment. Then the input tokens may represent any aspect of the health of a patient, e.g., data from blood and other medical tests on the patient and/or EHR (Electronic Health Record) data; and the output tokens may represent diagnostic information e.g., relating to a disease status of the patient and/or relating to suggested treatments for the patient, and/or relating to a likelihood of an adverse health event for the patient.

As mentioned above, the sequence-to-sequence model machine learning model may be a language model e.g., a language model neural network. In general, a language model neural network is a neural network that has been trained so that, given a text prompt that includes a sequence of tokens in a natural language, the neural network can generate the next token in the sequence. This process can be repeated to extend the text prompt one token at a time to generate a natural language output, i.e., to generate the natural language output auto-regressively token by token. At each time “time step,” the language model neural network processes the current sequence to generate a probability distribution over a vocabulary of tokens. The next token can then be selected using the probability distribution, e.g., by sampling from the distribution using nucleus sampling or another sampling technique or by selecting the highest-probability token. The tokens in the vocabulary can include any of a variety of tokens, e.g., some combination of words, sub-words, characters, punctuation and other symbols, and numbers. In general, the language model neural network is trained on a corpus of text made up of tokens from the vocabulary (and optionally other tokens that can be mapped to a designated out-of-vocabulary token), to predict the next token in a sequence of tokens from the training data.

It is surprising, but well-established, that large language model neural networks can perform tasks that they were not explicitly trained to perform. For example, they can perform translation tasks (provided that the training corpus included words in different languages), arithmetic, and many other tasks.

A language model neural network can be made to perform a particular task by providing a natural language description of the desired response as an input or “prompt” (input sequence). In some cases, the prompt may be a few-shot prompt where a few, e.g., 1 to 10, examples of a query and an example output are provided in the text prior to the actual query.

Instead or in addition, a language model neural network may be “fine-tuned” to perform a particular task, by obtaining a pre-trained language model neural network trained on a large corpus of examples as previously described and then further training part of all of the language model neural network on a relatively small number of examples particular to the type of task that is to be performed.

The language model neural network may be a large language model neural network, e.g., one that has greater than 1 billion, 10 billion or 100 billion trained parameters. The language model neural network may have been trained on greater than 10 billion, 100 billion or 1000 billion words or tokens representing words or other text tokens, e.g., sub-words (also known as “word pieces”).

In some implementations, the language model neural network is an autoregressive transformer neural network, where a transformer neural network is characterized by having a succession of self-attention neural network layers. A self-attention neural network layer has an attention layer input for each element of the input and is configured to apply an attention mechanism over the attention layer input to generate an attention layer output for each element of the input; there are many different attention mechanisms that may be used. In some implementations, the language model neural network can be a mixture-of-experts model.

Generally, an attention mechanism maps a query and a set of key-value pairs to an output, where the query, keys, and values are all vectors. The output is computed as a weighted sum of the values, where the weight assigned to each value is computed by a compatibility function, e.g., a dot product or scaled dot product, of the query with the corresponding key. For example an output of the attention mechanism may be determined as

$$softmax ( \frac{{QK}^{T}}{\sqrt{d}} ) V$$

where d is a dimension of the key (and value) vector, where query vector Q=XW^{Q}, key vector K=XW^{K}, and value vector V=XW^{V}, with input token sequence X and learned query matrix W^{Q}, learned key matrix W^{K}, and learned value matrix W^{V}. The output may be processed by one or more fully-connected, feed forward neural network layers. A layer norm operation may also be incorporated. The attention mechanism may implement multi-head attention, that is it may apply multiple different attention mechanisms in parallel. The outputs of these may then be combined, e.g., concatenated, with a learned linear transformation applied to reduce to the original dimensionality if necessary.

As a particular example, the sequence-to-sequence machine learning model can comprise a multimodal model in which one or both of the model input (i.e., input token sequence) and the model output (i.e., output token sequence) comprise an image or audio. For example, the multimodal machine learning model may be configured to process an input token sequence comprising visual tokens representing pixels of a still or moving image (which here may include a point cloud image), and/or data representing an audio waveform, e.g., values or features of the audio waveform such as audio tokens, and/or text tokens representing a sequence of text, to generate an output sequence, e.g., comprising text tokens representing the still or moving image or audio waveform, and/or comprising a sequence of intensity value inputs for the pixels of an image or a sequence of values defining an audio waveform. A visual token may, e.g., represent multiple pixels in a region of the image, e.g., as features of the region. Such a multimodal model may perform any of the previously described tasks, e.g., using a multimodal input, or by providing a multimodal output, or by converting between different input and output modes (e.g., text/image/audio). For example, it may generate text representing, describing (e.g., captioning), or otherwise characterizing an image or audio input, e.g., by answering a question related to the image or audio input, e.g., relating to a future e.g., physical prediction of a state of objects represented by the image or audio. As another example, it may generate an image or audio represented, described, or otherwise characterized by a text input, or otherwise in response to the text input, e.g., representing an image or audio answer to a text question.

A user computing device may be provided an input mechanism that enables user input from the user in a natural language and an output mechanism that provides a system output to the user in the natural language. The input and output mechanism may comprise, e.g., a keyboard and display. Also or instead, the input and output mechanism may comprise a speech-based mechanism. For example, the input mechanism may comprise a system configured to input audio data characterizing a speech waveform of speech representing the input from the user in the natural language and configured to convert the audio data into tokens representing the speech in the natural language, e.g., representing a transcription of the spoken input. The output mechanism may comprise a system configured to receive tokens representing the output to the user in the natural language and a system configured to convert the received tokens into audio data representing a waveform of speech representing the output to the user in the natural language, i.e., representing spoken words.

In some implementations, the input token sequence comprises one or more natural language statements relating to an environment, in particular a real-world environment, and includes a natural language request relating to the environment. Similarly the output token sequence may be a natural language reply or natural language output statement that also relates to the environment i.e., it provides information relating to the environment, which in some implementations may relate to or specify actions to be taken in the environment.

In some implementations, the environment is a real-world environment and the method (or a corresponding system) is used for diagnosing a fault in a mechanical system operating in the real world environment. Then, obtaining the input token sequence may comprise obtaining from one or more sensors, e.g., as described below, one or more observations of the mechanical system (which here includes observations of the operation of mechanical system). These are processed, e.g., as described below, to generate a natural language representation of the one or more observations that is used to provide one or more of the natural language statements of the input token sequence. In these implementations, the natural language request relates to the operation of the mechanical system and the natural language reply or the natural language output statement is used to identify a fault in the mechanical system. For example, the request may comprise a general question such as “Is the system working correctly?” or “What is wrong with the system?” or a specific request such as “Is there a fault with component X?”. The ability to hold a dialogue with an agent comprising the sequence-to-sequence model neural network facilitates homing in on a particular fault diagnosis. The diagnosis can use information stored within the trained sequence-to-sequence neural network, which can also use the ability to search an external data store to supplement the stored information with more comprehensive or more recent information as needed.

As another example, the environment can be a computer security monitoring environment, e.g., the system can be deployed as part of a system that monitors the security of one or more computers in one or more locations. For example, the environment may be a computer network security monitoring environment, and the system can be deployed as part of a system that monitors the security of one or more computers on a computer network, e.g., a wireless network, a cellular network, a local area network and/or the internet. As another example, the environment may alternatively or additionally be a computer system security monitoring environment and the system can be deployed as part of a system that monitors the system for the presence of computer viruses and/or an unresolved software vulnerability, e.g., a zero-day exploit. A software vulnerability may be resolved by updating the software (e.g., patching) and/or removing (e.g., uninstalling) the software from the computer system. In these examples, the natural language request can query whether a computer security incident has been resolved (e.g., “has the incident been resolved?”) and the input token sequence may comprise relevant statements from system logs, i.e., that are potentially relevant to the event being queried. A computer security incident can be, e.g., a data breach, an unauthorized log-in or other access of a secured system, a detection of a computer virus or detection of a software vulnerability. The incident can be “resolved” when the underlying incident is no longer a threat to the security of the computer system e.g., the computer virus has been removed, the access to the secured system has been removed, the data breach has been mitigated, or the software having the vulnerability has been updated or removed. The system can use the input token sequence to generate a reply to the request that comprises a natural language statement indicating whether the incident has been resolved, optionally displaying evidence used to determine this.

The input token sequence may include one or more of: code snippets from the software code, system logs, program logs, or other artifacts that should be left on the computer by running the program, or verification rules that represent requirements for the execution of the software program, or natural language statements describing the computer system on which the software executes. In general, the input token sequence may include relevant statements, i.e., statements that are potentially relevant to the event being queried.

In some implementations obtaining the input token sequence may comprise obtaining, from the system logs, the data characterizing the computer network, or both, or from other data as described above, one or more observations of the computer network (which here includes computers on the network), and processing the one or more observations to generate a natural language representation of the one or more observations. The natural language request may relate to the computer security incident or to the secure operation of the computer network. The method may include using the natural language representation of the one or more observations to provide one or more of the natural language statements describing the computer network, and using the natural language reply or the natural language output statement to identify a security status of the computer network or a security flaw in the computer network.

As another example, the environment can be a software testing or evaluation environment, e.g., the system can be deployed as part of a system that tests software before deployment or that evaluates already-deployed software to identify bugs. In these examples, when the system tests software before deployment, the natural language request can ask whether the software will execute as intended, and the input token sequence can include code snippets from the software code and, optionally, natural language statements describing the computer system on which the software will execute. The system can then use the input token sequence to generate a reply that indicates whether the code will execute as intended, optionally displaying evidence used to determine this. When the system monitors the execution of code after deployment, the natural language request can ask whether a software program, or a portion of a software program, has executed as intended, and the input token sequence can include one or more of: code snippets from the software code, system logs, program logs, or other artifacts that should be left on the computer by running the program, or verification rules that represent requirements for the execution of the software program, or natural language statements describing the computer system on which the software executes. The system can then use the input token sequence to generate a reply that indicates whether the code has executed as intended, optionally displaying evidence used to determine this. As a particular example, the software program can be part of the boot up of a computer, and the system can generate a reply each time that the computer starts up to verify whether the computer will function correctly after start up.

As another example, the environment can be an educational environment, e.g., the system can be deployed as part of an education software program that assists a user in learning or practicing one or more corresponding skills. In these examples, the input token sequence can include natural language statements describing or referencing a scenario or scene in a real-world or imagined environment, and the request can be a question about the scenario or scene.

As another example, the environment can be an information retrieval environment, e.g., the system can be deployed as part of a search engine or other software that allows a user to search for information in a corpus of documents, e.g., the Internet or another electronic document corpus. In these examples, the request can be any appropriate natural language question, and the reply can optionally include evidence such as include relevant statements from the corpus of documents, e.g., as identified by searching the corpus using conventional information retrieval techniques.

In some implementations, the language model neural network is a visual language model (VLM). In general, the VLM may process input token sequences comprising tokens that each represent natural language or (a part of) an image or video to generate output tokens that each represent natural language or (a part of) an image or video. For example, the VLM may be configured to describe an image or video using natural language, e.g., to perform an image or video captioning task. As another example, the VLM may be configured to process input tokens representing an image and text tokens representing a query about the image or a request to modifying the image, and to generate output tokens representing an answer to the query or representing a version of the image that has been modified in accordance with the request. The VLM may generate output tokens representing an image or video that is generated in response to input tokens providing a visual and/or audio and/or textual description of a desired image or video.

In some implementations, the “language” of the language model is not a natural language such (e.g., English), but may instead be a text-based encoding describing an entity or class of entities, e.g., a chemical or biological entity, such as a chemical structure or molecule. For example, the text-based encoding may be a sequence of tokens that defines a molecule or protein, e.g., a sequence specifying an arrangement of atoms or chemical functional groups in a molecule, or the amino acid residues of a protein. The language model may be referred to as a chemical and/or biological language model in such cases. The input for the language generation neural network may therefore be an input string defining a chemical (e.g., protein) structure and the output may be an output string defining a different chemical structure from the input string. The strings may be in the Simplified Molecular Input Line Entry System, SMILES, format, for example.

In some implementations, the language model neural network may be used to interact with a human user of a digital assistant such as a smart speaker, smart display, or other device. For example, information defining a task can be obtained from the digital assistant, and the digital assistant can be used to instruct the user to perform the task. For example, this may comprise receiving, at the digital assistant, a request from the user for assistance and determining, in response to the request, a series of tasks for the user to perform, e.g., steps or sub-tasks of an overall task. Then for one or more tasks of the series of tasks, e.g., for each task, e.g., until a final task of the series, the digital assistant can be used to output to the user an indication of the task, e.g., step or sub-task, to be performed. This may be done using natural language, e.g., on a display and/or using a speech synthesis subsystem of the digital assistant. Visual, e.g., video, and/or audio observations of the user performing the task may be captured, e.g., using the digital assistant. A system may then be used to determine whether the user has successfully achieved the task, e.g., step or sub-task, i.e., from the answer as previously described. If there are further tasks to be completed the digital assistant may then, in response, progress to the next task (if any) of the series of tasks, e.g., by outputting an indication of the next task to be performed. In this way, the user may be led step-by-step through a series of tasks to perform an overall task.

As an illustrative example, a user may be interacting with a digital assistant and ask for help performing an overall task consisting of multiple steps, e.g., cooking a pasta dish. While the user performs the task, the digital assistant receives audio and/or video inputs representative of the user's progress on the task, e.g., images or video or sound clips of the user cooking. The digital assistant uses a system as described above, in particular by providing it with the captured audio and/or video and a question that asks whether the user has completed a particular step, e.g., “Has the user finished chopping the peppers?”, to determine whether the user has successfully completed the step. If the answer confirms that the user has successfully completed the step then the digital assistant progresses to telling the user to perform the next step or, if at the end of the task, or if the overall task is a single-step task, then the digital assistant may indicate this to the user. The digital assistant may then stop receiving or processing audio and/or video inputs to ensure privacy and/or reduce power use.

In a further aspect, there is provided a digital assistant device including a system as described above. The digital assistant can also include a user interface to enable a user to request assistance and to output information. In implementations, this is a natural language user interface and may comprise a keyboard, voice input-output subsystem, and/or a display. The digital assistant can further include an assistance subsystem configured to determine, in response to the request, a series of tasks for the user to perform. In implementations this may comprise a generative (large) language model, in particular for dialog, e.g., a conversation agent such as LaMDA. The digital assistant can have an observation capture subsystem to capture visual and/or audio observations of the user performing a task; and an interface for the above-described language model neural network (which may be implemented locally or remotely). The digital assistant can also have an assistance control subsystem configured to assist the user. The assistance control subsystem can be configured to perform the steps described above, for one or more tasks, e.g., of a series of tasks, e.g., until a final task of the series. More particularly, the assistance control subsystem and output to the user an indication of the task to be performed, capture, using the observation capture subsystem, visual or audio observations of the user performing the task, determine from the above-described answer whether the user has successfully achieved the task. In response, the digital assistant can progress to a next task of the series of tasks and/or control the digital assistant, e.g., to stop capturing observations.

### Image Processing

In general, the sequence-to-sequence machine learning model can be used to perform an image processing task, e.g., on a compressed input token sequence that represents one or more images.

As one example, the sequence-to-sequence machine learning model can be used to perform a still or moving image classification task. For example, the compressed input token sequence may represent an image of a vehicle, and the model can generate an output token sequence classifying the image into one of a plurality of classes, e.g., pickup truck, car, or van. Input tokens representative of the possible classes, or providing additional context for the image, can be included in the input token sequence in some cases. A similar approach may be used to classify actions in moving images, e.g., gestures; and to perform a multi-label classification.

As another example, the sequence-to-sequence machine learning model may be used to perform (unsupervised) semantic segmentation of an image, e.g., by applying a clustering algorithm such as k-means clustering, e.g., to image tokens in the input token sequence. This can cluster or classify each image token (patch) into one of a set of categories, e.g., by determining defining a score for each category of a set of possible categories. The semantic segmentation can also be performed based on input tokens representing a text label, e.g., to segment the image according to a description, e.g., object definition, in the text label. In general, the output of any dense prediction task, e.g., a semantic or other segmentation task, may comprise a value for each pixel or image token that defines the desired output, e.g., a value for each pixel or image token that defines a class or category to which the pixel or image token belongs for a segmentation task, or a depth value for a depth estimation task, and so forth.

In general, techniques and architectures for processing image representations, e.g., image token representations, to perform image processing tasks are well known. For example, many examples have previously been described for Vision Transformer neural networks (that also generate image token representations). Architectures such as these (e.g., Vision Transformers) can be trained to process compressed input token sequences.

For example, the image processing task can comprise one or more of: image segmentation, e.g., semantic segmentation or instance segmentation; depth prediction; keypoint prediction; pose estimation, e.g., 3D pose estimation; surface normal estimation, e.g., by determining a vector in 2D or 3D; or object detection, including object tracking; or gesture recognition. In general, any prediction task may be performed, e.g., by determining a scalar or vector value for each image token of an image. Other types of task may be performed in the same way, e.g., a curvature or other shape estimation task, a task that involves identifying aspects of an image using color, a counting task that involves counting objects or objects of a particular type, a task that involves understanding spatial relationships between objects or object attributes, and so forth.

Some other tasks that can be performed using the sequence-to-sequence machine learning model include image enhancement, image colorization, and image super-resolution, i.e., to generate output data that comprises an enhanced, colorized, or super-resolution version of an input image.

As one example, in an image segmentation task the patch embeddings may be processed to assign a categorical value defining a category for the patch, or a value representing a probability that the patch belongs to a particular category. The category may represent an object or type of object or (for video) an action or type of action. For example, in a semantic segmentation task the patch values may identify a type or category of object and in an instance segmentation task the values may (also) distinguish between different instances of the same category of object. More generally a value can distinguish between an object (or action) and image background, and the set of patch embeddings for an image can, e.g., perform an object localization, detection, or tracking task, e.g., for gesture recognition, i.e., recognition of gestures that are performed by entities depicted in a video.

Also or instead the image tokens may be processed by the model to determine data representing one or more bounding boxes or other location data for an object or type of object in the processed image or, for moving images, location data for an action or type of action in the processed image. Such location data may comprise, e.g., data defining coordinates of a bounding box or region for one or more objects represented in the image. Such a bounding box or region may be defined in two, three or more dimensions (time counting as a dimension). Such location data may contribute to higher level tasks, e.g., to object tracking across video frames.

Merely as some further illustrative examples, object segmentation may be used to segment medical images, to label patches of an input medical image in accordance with whether they show a region of a human or animal body in which a particular medical condition is present. An object segmentation may be used to provide an input to a control system of a mechanical agent, such as a robot or vehicle operating in a real-world environment. The detected objects may be, e.g., obstacles or paths upon which the mechanical agent can move, and may be used by the control system, e.g., to make decisions on how to accomplish a task performed by the robot, or for controlling the direction or speed of movement of the agent.

As another example, in a (monocular) depth prediction task the image tokens may be processed to obtain a scalar patch value representing an estimated depth value for the token, e.g., a distance of the token in a depth or z-direction from an x-y image plane or camera viewpoint.

As another example, in a keypoint prediction task the output token sequence may identify keypoints in the image, e.g., by labelling an image token as a keypoint or as one of multiple keypoints. A set of values for the patches can thus label keypoints in the image that may, e.g., define landmarks of an object represented in the image, e.g., the positions of body joints for a human.

As another example, in a pose estimation task the output token sequence may map the image tokens to a 3D surface, e.g., of a human body or face. Or the output tokens may estimate a 6D pose representing translation and orientation components of an object in the image, e.g., in quaternion form. The output token sequence for the image can estimate the pose of one or more objects in the image.

As another example, in a surface normal estimation task the output token sequence may comprise a vector in, e.g., three dimensions defining a surface normal, for each of the image tokens. The output token sequence can provide a surface normal map for one or more objects in the image, e.g., for use in an augmented reality or other application.

In some applications, the sequence-to-sequence machine learning model can be configured to perform a media item (such as an image or sound) processing task that comprises any one or more of:
(i) classification (CLS), i.e., assigning an input token sequence representing a media item (e.g., image) to one (or more) of set of classes based on content of the media item. Note that “content” here means content defined by pixelated intensity values in the case that the media item is an image, or defined by amplitude values in the case that the media item is a sound.
(ii) captioning (generating a caption, such as a sequence of tokens selected from a vocabulary) describing the content of the media item;
(iii) question answering, e.g., visual question answering (VQA), of generating an answer which is an appropriate response to a question about the media item;
(iv) a segmentation task of identifying a (proper) subset of the media item having specific properties, such as properties defined by the text tokens in the input token sequence, e.g., for a media item which is an image, “a penguin in the foreground”, “cancerous material”; or for a media item which is a sound signal, “a child crying after a dog has barked”; and
(v) an agent control task of generating control data for an agent in an environment (e.g., an electro-mechanical agent such as a robot) based on a media item describing the environment (e.g., received sensor data, such as an image of an environment captured by a camera) and a text token sequence defining an action the robot is instructed to perform.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer pro-grams, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a mark-up language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, sub-system, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide in-put to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for ex-ample, special-purpose hardware accelerator units for processing common and compute-intensive parts of machine learning training or production, i.e., inference, workloads.

Machine learning models can be implemented and deployed using a machine learning frame-work, e.g., a TensorFlow framework or a JAX framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel pro-cessing may be advantageous.

1. A method performed by one or more computers and for generating an output token sequence from an input token sequence, the method comprising:
processing an input token sequence using a sequence-to-sequence machine learning model to generate an output token sequence, the sequence-to-sequence machine learning model having a vocabulary comprising primary tokens for representing token sequences and pointer tokens for representing pointers to token sequences,
wherein at least one of the input token sequence and the output token sequence is a compressed token sequence comprising a respective one or more pointer subsequences, each pointer subsequence comprising one or more pointer tokens representing a pointer to a corresponding earlier subsequence of primary tokens in the compressed token sequence.

2. The method of claim 1, further comprising generating the input token sequence from an initial token sequence comprising primary tokens, comprising:
identifying one or more matching subsequences of primary tokens in the initial token sequence, each matching subsequence being a match to a corresponding earlier subsequence in the uncompressed subsequence; and
for each of the one or more matching subsequences, replacing one or more occurrences of the matching subsequence in the initial token sequence with a corresponding pointer subsequence comprising one or more pointer tokens representing a pointer to the corresponding earlier subsequence in the initial token sequence.

3. The method of claim 1, wherein the output token sequence is a compressed output token sequence, the method further comprising generating an uncompressed output token sequence, the generating comprising replacing each pointer subsequence with the primary tokens of the corresponding earlier subsequence in the compressed output token sequence.

4. The method of claim 1, wherein each pointer subsequence comprises one or more pointer tokens representing a length of the corresponding earlier subsequence.

5. The method of claim 4, wherein each pointer subsequence comprises one or more tokens representing a corresponding offset in the compressed token sequence for the corresponding earlier subsequence of primary tokens relative to the pointer subsequence.

6. The method of claim 1, wherein the sequence-to-sequence machine learning model is an autoregressive sequence-to-sequence machine learning model.

7. The method of claim 1, wherein the sequence-to-sequence machine learning model is a language model and the input token sequence represents a text query.

8. The method of claim 7, wherein the input token sequence comprises primary tokens that represent respective multi-character substrings of the text query.

9. The method of claim 8, wherein the compressed token sequence comprises pointer subsequences of pointer tokens representing pointers to corresponding earlier subsequences of primary tokens representing elements of one or more of: a mark-up language, a computer programming language, and a language used to manage data in a relational database management system.

10. The method of claim 1, wherein the sequence-to-sequence machine learning model comprises a base neural network configured to generate an embedding of an input token sequence, the base neural network having been trained to generate embeddings of input token sequences as a part of another sequence-to-sequence model that has a vocabulary that does not comprise pointer tokens.

11. The method of claim 10, wherein the base neural network comprises blocks of base neural network layers and the sequence-to-sequence machine learning model comprises one or more adapter blocks, each adapter block comprising adapter neural network layers arranged to modify the output of a corresponding one or more of the blocks of base neutral network layers.

12. The method of claim 11, wherein the adapter neural network layers of each adapter block are defined by low-rank factorization matrices.

13. The method of claim 11, wherein each adapter block processes an input to the corresponding one or more of the blocks of base neural network layers to generate a corresponding output that is combined with the output of the one or more of the blocks of base neural network layers.

14. The method of claim 11, wherein the adapter neural network layers have been trained using compressed input token sequences and/or compressed output token sequences.

15. The method of claim 14, wherein the adapter neural network layers have been trained using compressed input token sequences and/or compressed output token sequences while trainable parameters of the base neural network layers are frozen.

16. A method performed by one or more computers and for generating an output token sequence from an input token sequence, the method comprising:
receiving an input token comprising primary tokens for representing token sequences;
generating a compressed input token sequence from the input token sequence, generating the compressed input token sequence comprising:
identifying one or more matching subsequences of primary tokens in the input token sequence, each matching subsequence being a match to a corresponding earlier subsequence in the input token sequence; and
for each of the one or more matching subsequences, replacing one or more occurrences of the matching subsequence in the input token sequence with a corresponding pointer subsequence comprising one or more pointer tokens representing a pointer to the corresponding earlier subsequence in the input token sequence; and
processing the compressed input token sequence using a sequence-to-sequence machine learning model to generate an output token sequence, the sequence-to-sequence machine learning model having a vocabulary comprising the primary tokens and the pointer tokens.

17. The method of claim 16, wherein the output token sequence comprises a respective one or more pointer subsequences, each pointer subsequence comprising one or more pointer tokens representing a pointer to a corresponding earlier subsequence of primary tokens in the output token sequence.

18. The method of claim 17, further comprising replacing each pointer subsequence in the output token sequence with the primary tokens of the corresponding earlier subsequence in the output token sequence.

19. A method performed by one or more computers and for generating an output token sequence from an input token sequence, the method comprising:
processing an input token sequence using a sequence-to-sequence machine learning model to generate a compressed output token sequence, the sequence-to-sequence machine learning model having a vocabulary comprising primary tokens for representing token sequences and pointer tokens for representing pointers to token sequences, and
wherein the compressed output token sequence comprises a respective one or more pointer subsequences, each pointer subsequence comprising one or more pointer tokens representing a pointer to a corresponding earlier subsequence of primary tokens in the compressed output token sequence.

20. The method of claim 19, further comprising replacing each pointer subsequence with the primary tokens of the corresponding earlier subsequence in the compressed output token sequence.

21. The method of claim 19, further comprising transmitting the compressed token sequence to or from a user computer device.

22. The method of claim 19, wherein the method is for controlling a mechanical system acting in a real world environment to perform a specified task, wherein:
the input token sequence represents one or more observations of the real world environment obtained from one or more sensors; and
the output token sequence represents instructions for controlling the mechanical system in the real world environment; and
the method further comprises:
using the output token sequence to control the mechanical system in the real world environment.
